(19) United States
(12) Patent Application Publication
(10) Pub. No.: US 2022/0138796 A1
(43) Pub. Date: May 5, 2022

(54) SOCIAL MEDIA CONTENT CREATOR SUPPORT

(71) Applicant: DISPLAY SOCIAL, INC., Norwalk, CT (US)

(72) Inventor: John ACUNTO, Fairfield, CT (US)

(21) Appl. No.: 17/513,566

(22) Filed: Oct. 28, 2021

Related U.S. Application Data
(60) Provisional application No. 63/107,210, filed on Oct. 29, 2020.

(51) Int. Cl. G06Q 30/02; G06Q 50/00

(52) U.S. Cl. CPC G06Q 30/0247; G06Q 50/01; G06Q 30/0255

(57) ABSTRACT

Value sharing for a social network is provided. One or more servers send, to a client device of a first user of the social network, a support me icon in association with a post on the social network, the post having been created by a second user of the social network, the support me icon configured to cause an advertisement to be presented to the first user responsive to selection of the support me icon by the first user. The one or more servers receive, from the client device, an indication that the advertisement was presented to the to the first user. The one or more servers allocate, to the second user, a first portion of value corresponding to the presentation of the advertisement to the first user, thereby compensating the second user for creating the post on the social network.

### CROSS REFERENCE TO RELATED APPLICATIONS

This application claims the benefit of U.S. provisional application Ser. No. 63/107,210, filed on Oct. 29, 2020, the disclosure of which is hereby incorporated in its entirety by reference herein.

### TECHNICAL FIELD

Aspects of the disclosure generally relate to revenue sharing for a social network. For instance, aspects relate to supporting social media content creators by revenue sharing for voluntary viewing of advertisements by content consumers of the social media content. Additionally, aspects relate to enabling e-commerce within the social media network and splitting affiliate purchase fees with the social media content creators.

### BACKGROUND

A social network is an online platform where people build networks of their social relationships with other people. These relationships may be used to share content with other users. This content may include text, images, and videos created by the users. This content may also include content created by users that is flagged as interesting by other users.

### SUMMARY

In one or more illustrative examples, a system for value sharing for a social network is provided. One or more servers are programmed to send, to a client device of a first user of the social network, a support me icon in association with a post on the social network, the post having been created by a second user of the social network, the support me icon configured to cause an advertisement to be presented to the first user responsive to selection of the support me icon by the first user. The one or more servers are further programmed to receive, from the client device, an indication that the advertisement was presented to the to the first user. The one or more servers are further programmed to allocate, to the second user, a first portion of value corresponding to the presentation of the advertisement to the first user, thereby compensating the second user for creating the post on the social network.

In one or more illustrative examples, a method for value sharing for a social network is provided. One or more servers send, to a client device of a first user of the social network, a support me icon in association with a post on the social network, the post having been created by a second user of the social network, the support me icon configured to cause an advertisement to be presented to the first user responsive to selection of the support me icon by the first user. The one or more servers receive, from the client device, an indication that the advertisement was presented to the to the first user. The one or more servers allocate, to the second user, a first portion of value corresponding to the presentation of the advertisement to the first user, thereby compensating the second user for creating the post on the social network.

In one or more illustrative examples, a non-transitory computer-readable medium includes instructions for value sharing for a social network that, when executed by one or more servers, cause the one or more servers to perform operations including to send, to a client device of a first user of the social network, a support me icon in association with a post on the social network, the post having been created by a second user of the social network, the support me icon configured to cause an advertisement to be presented to the first user responsive to selection of the support me icon by the first user; receive, from the client device, an indication that the advertisement was presented to the to the first user; and allocate, to the second user, a first portion of value corresponding to the presentation of the advertisement to the first user, thereby compensating the second user for creating the post on the social network.

### BRIEF DESCRIPTION OF THE DRAWINGS

FIG. 1 illustrates an example system for supporting social media content creators by way of voluntary viewing of advertisements;

FIG. 2 illustrates an example user interface of the social network including a support me icon;

FIG. 3 illustrates another example user interface of the social network including an ad displayed responsive to selection of the support me icon;

FIG. 4 illustrates an example user interface displaying exclusive content post functionality;

FIG. 5 illustrates an example data flow for advertisements provided for viewing using the support me icon;

FIG. 6 illustrates an example data flow for retry mechanics of the delivery of advertisements provided for viewing using the support me icon;

FIG. 7 illustrates an example user interface displaying an account balance screen for a user of the social network;

FIG. 8 illustrates an example user interface displaying a store for a user of the social network;

FIG. 9 illustrates an example user interface displaying selection of an e-commerce web site;

FIG. 10 illustrates an example user interface displaying items available in a selected e-commerce website;

FIG. 11 illustrates an example user interface displaying a search feature for finding items available in a selected e-commerce website;

FIG. 12 illustrates an example user interface displaying found items located using the search feature;

FIG. 13 illustrates an example user interface displaying the list of matching items along with selection of an item from the e-commerce website;

FIG. 14 illustrates an example user interface displaying the store for a user of the social network including the newly added item;

FIG. 15 illustrates an example user interface displaying a profile page for a user adding a post;

FIG. 16 illustrates an example user interface displaying a create post screen;

FIG. 17 illustrates an example user interface displaying an image gallery page for adding an image to a post;

FIG. 18 illustrates an example user interface displaying the create post screen tag option;

FIG. 19 illustrates an example user interface displaying a selector for the store;

FIG. 20 illustrates an example user interface displaying a selection of items from the selected store to add to the post;

FIG. 21 illustrates an example user interface displaying the create post screen including the tag for the selected item from the store;

FIG. 22 illustrates an example user interface displaying the post including a tag for the selected item from the store;

FIG. 23 illustrates an example user interface displaying further details of the post including a highlight the tag for selecting to purchase the items from the user's store;

FIG. 24 illustrates details of an example computing device for use in the illustrated systems and methods; and

FIG. 25 illustrates a computing device for use in the described systems and methods.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A content creating user of a social network may desire compensation for adding new content to the social network. This support may be accomplished by other users of the social network clicking on a support icon associated with the content creator's posts. When clicked, the support icon may cause the user to watch an advertisement (e.g., a video or a static advertisement). Upon completion of the advertisement, the content creating user may be rewarded based on the amount of ad revenue for viewing the advertisement. This may be done by depositing or otherwise applying awards or money from that portion of ad revenue to an account balance of the content creating user.

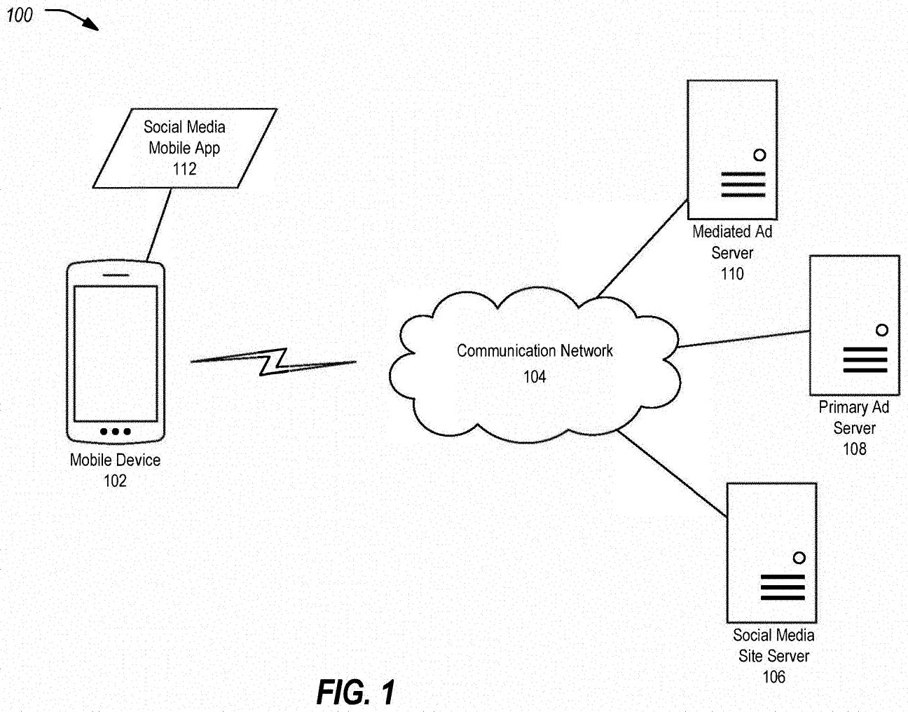

FIG. 1 illustrates an example system 100 for supporting social media content creators by way of voluntary viewing of advertisements. As shown, a mobile device 102 executes a social media mobile application 112 (e.g., a mobile application, a web browser application, etc.) and is in communication with a social media site server 106 over a communications network 104. The mobile device 102 is served advertisements by way of the primary ad server 108 and mediated ad server 110, as discussed in detail below.

The mobile device 102 may be any of various types of computing device, such as cellular phones, tablet computers, smart watches, laptop computers, desktop computers, portable music players, or other devices having processing and communications capabilities. The mobile device 102 may further include various wireless transceivers, such as a BLUETOOTH, BLE, ultra-wide band (UWB), and/or Wi-Fi transceiver, as well as a transceiver for communication over a communications network 104.

The communications network 104 may include one or more interconnected communication networks such as the Internet, a cable television distribution network, a satellite link network, a local area network, and a telephone network, as some non-limiting examples. The communications network 104 may provide communications services, such as packet-switched network services (e.g., Internet access, voice over Internet Protocol (VoIP) communication services), to devices connected to the communications network 104. An example of a communications network 104 is a cellular telephone network. For instance, the mobile device 102 may access the cellular network via connection to one or more cellular towers. To facilitate the communications over the communications network 104, the mobile device 102 may be associated with unique device identifiers (e.g., mobile device numbers (MDNs), Internet protocol (IP) addresses, etc.) to identify the communications of the mobile device 102 on the communications network 104 as being associated with the mobile device 102.

The social media site server 106, primary ad server 108, and mediated ad server 110 may each be examples of a networked computing device that is accessible to the mobile device 102 over the communications network 104. These servers 106, 108, 110 may include various types of computing apparatus, such as a computer workstation, a server, a desktop computer, a virtual server instance executed by a mainframe server, or some other computing system and/or device.

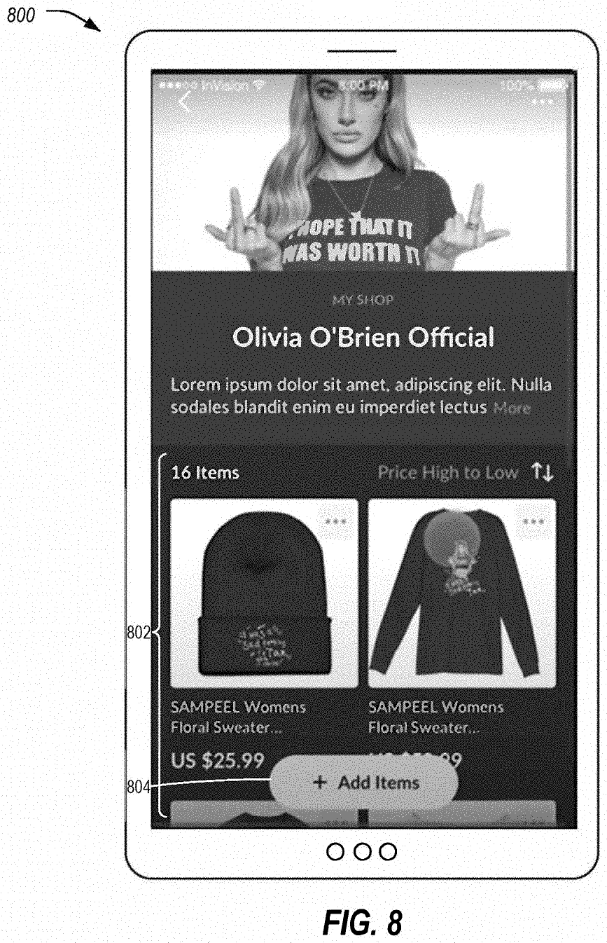

Computing devices, such as the mobile device 102, social media site server 106, primary ad server 108, and mediated ad server 110, generally include a memory on which computer-executable instructions may be maintained, where the instructions may be executable by one or more processors of the computing device. Such instructions and other data may be stored using a variety of computer-readable media. A computer-readable medium (also referred to as a processor-readable medium or storage) includes any non-transitory (e. g., tangible) medium that participates in providing data (e.g., instructions) that may be read by a computer (e.g., by the processor of the social media site server 106). In general, processors receive instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, PL/SQL, etc. Further details of computing devices are shown with respect to FIG. 8.

The social media site server 106 may be configured to provide users with access to a social network. A social network is an online platform upon which people build networks of their social relationships with other people in order to share content with those other users. The shared content may include text, images, and videos created by the users. The shared content may also include content created by users that is flagged as interesting by other users. The social media mobile application 112 may include instructions that, when executed by the one or more processors of the mobile device 102, cause the mobile device 102 to perform operations to facilitate the access to the social network of the social media site server 106.

Each user of the social media site server 106 may have an account with the social network. This account may include information such as the social network contacts (friends) of the user, a profile page for the user, and an interface for adding new content to the user's profile. The account may also be linked to an account balance. This balance may include awards or money that is earned by the user for activity on the social network. The balance may also be paid out to the user as an incentive to continue to use the social network. For instance, the balance may be redeemed via (i) online payment service, such as PAYPAL, VENMO, SQUARE, CASH, ZELLE, etc. or (ii) gift cards, (iii) bank debit cards or (iv) contributions to charitable organizations. In other examples, this balance may be used to make e-commerce purchases within the social network (discussed in detail below).

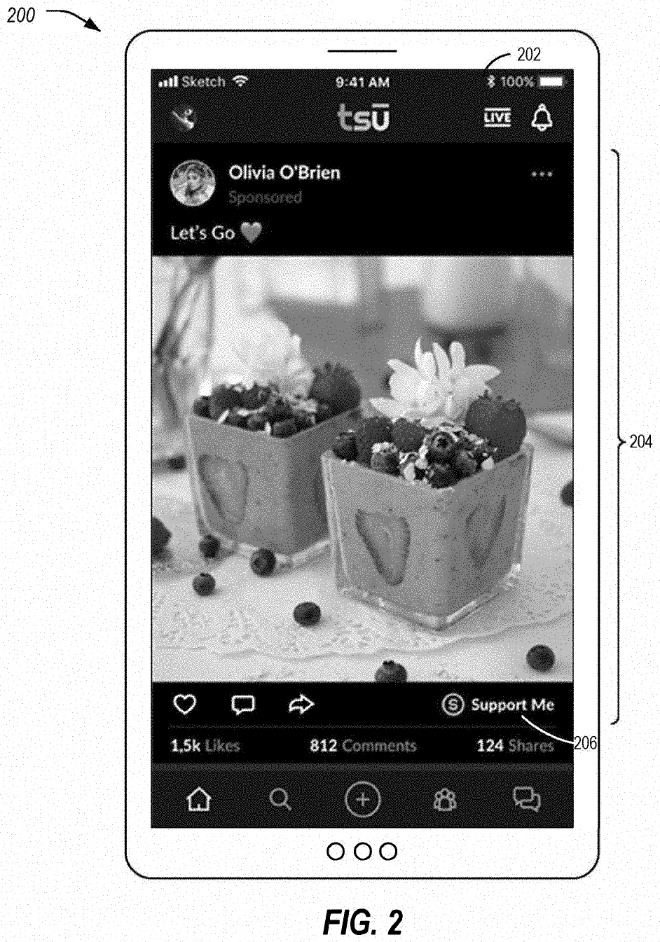

FIG. 2 illustrates an example user interface 200 of the social network including a support me icon 206. The mobile device 102 may include a display 202 configured to provide the user interface 200 to a user. In some examples, the display 202 may be touch-sensitive, and may be further configured to receive input from the user. The example user interface 200 may be provided by the social media mobile application 112 executed by the mobile device 102 in communication with the social media site server 106 over the communications network 104. When the support me icon 206 is selected by the user, an ad is displayed and a portion of the ad revenue is shared with the content creating user. By users clicking on the support me icon 206, the posting user receives revenue and is therefore incentivized to provide additional content to the social network.

As shown in the illustrated example, a user, Oliva, of the social network has added a post 204 of an image of a dessert, with the caption “let's go.” The post 204 further includes a support me icon 206. This post can be seen, for example, on the display 202 of a viewing user of the social network who is connected to the Olivia user. It should be noted that the user would not see the support me icon 206 on his/her own posts.

Responsive to the viewing user clicking (or touching) the support me icon 206, an ad may appear. The ad may be a static ad which is a fixed image, or a native ad which is a video or interactive ad. Regardless of type, once the ad appears and is viewed, the user can then close the ad. If the ad is a video ad, then the user may be required to watch the entire video ad before being able to close the ad.

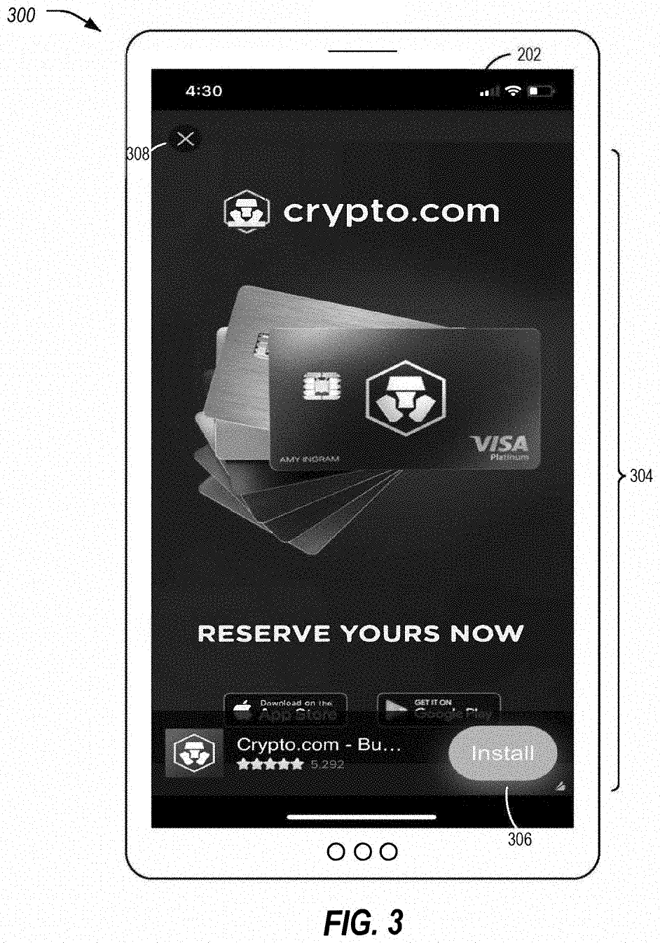

FIG. 3 illustrates another example user interface 300 of the social network including an ad 304 displayed responsive to selection of the support me icon 206. As shown in the illustrated example, the ad includes information about products or services, as well as controls 306 that may be clicked through to perform additional actions (here, the installation of an application on the user's mobile device 102). The ad also includes a close control 308 that may be selected to dismiss the ad and return to the content of the social network.

In online advertising, advertisers pay to have their ads shown and web site or other displayers of content receive revenue for the display and/or click-through of those ads. For instance, an ad has been viewed as shown in FIG. 3. In this instance, the social network may receive the revenue for the display of the ad. More specifically, the revenue may be received to the social network through the display of an ad responsive to users of the social network clicking the support me icon 206 on the post 204. Significantly, this revenue may be used to support the user who provided the content of the post 204 to the social network. For instance, the content creating user may be awarded based on a portion of ad revenue and applied to the account balance of the content creating user. In one non-limiting example, the content creating user is rewarded based on the 50% (or other defined percentage) of the ad revenue received by the social network. In an example, the revenue allocation may be performed daily (or based on another time period), to allocate ad revenue for the time period based on an aggregation of what was viewed for the time period.

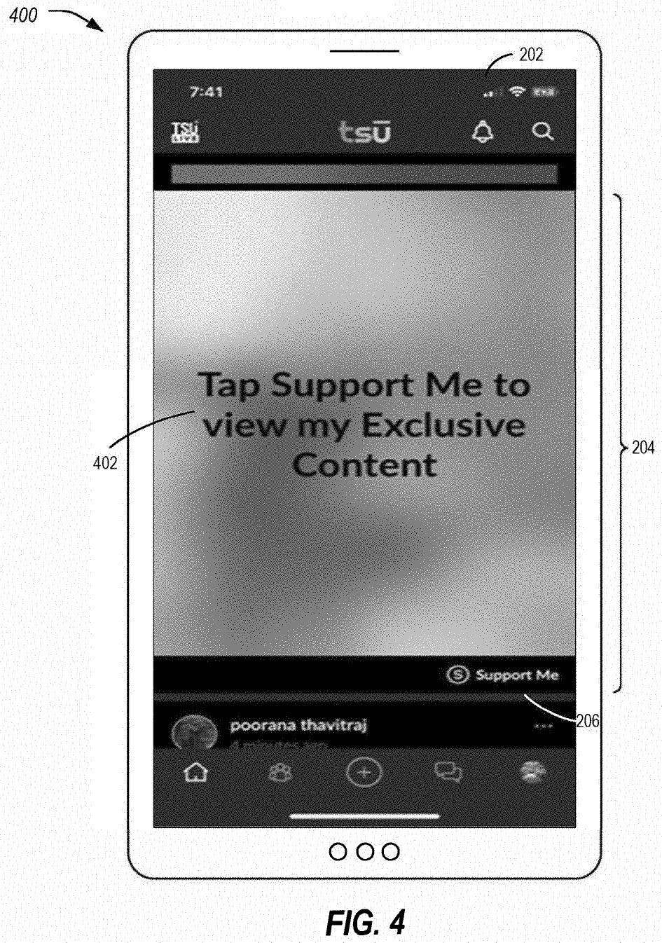

FIG. 4 illustrates an example user interface 400 displaying exclusive content post functionality. As shown, the post 204 in the example is obscured by a message 402 or is otherwise unavailable until the support me icon 206 is selected. The message 402, as shown, may direct the user to choose the support me icon 206 to watch the ad in order to view the content. After watching the ad, the user may then be allowed to view the exclusive post. Revenue for viewing the ad may be allocated between the social network and the content creator, as mentioned above. By receiving this revenue, the content creator is incentivized to provide new content to the social network.

To avoid having too much content locked up through this paywall-style functionality, limitations may be placed on the quantity of exclusive content posts that a content creator may provide. In one non-limiting example, the content creating user may only be allowed to provide one exclusive content post per day. This may be tracked according to the user's local calendar day. In one example, this may be tracked client-side by the social media mobile application 112, but there may also be server-side verification by the social media server 108 to avoid abuse of the feature by malicious users.

Apart from the paywall lock where the user must view an ad to see the content of the post, the exclusive post may otherwise be handled as a public post 204 to the social network. However, other limitations may be places on the exclusive posts to facilitate an open social network. As one possibility, an option may be implemented to cap the number of exclusive posts that a user can watch in a given time period (e.g., in a single day). As another possibility, exclusive posts may be locked down to be only visible to contacts of the content creating user and may not be allowed to be shared by another user (where a shared post 204 once shared may then be seen by the social network contacts of the sharing user). It should be noted that until the ad is viewed for the exclusive content, a user may be unable to like or comment on the exclusive content post 204.

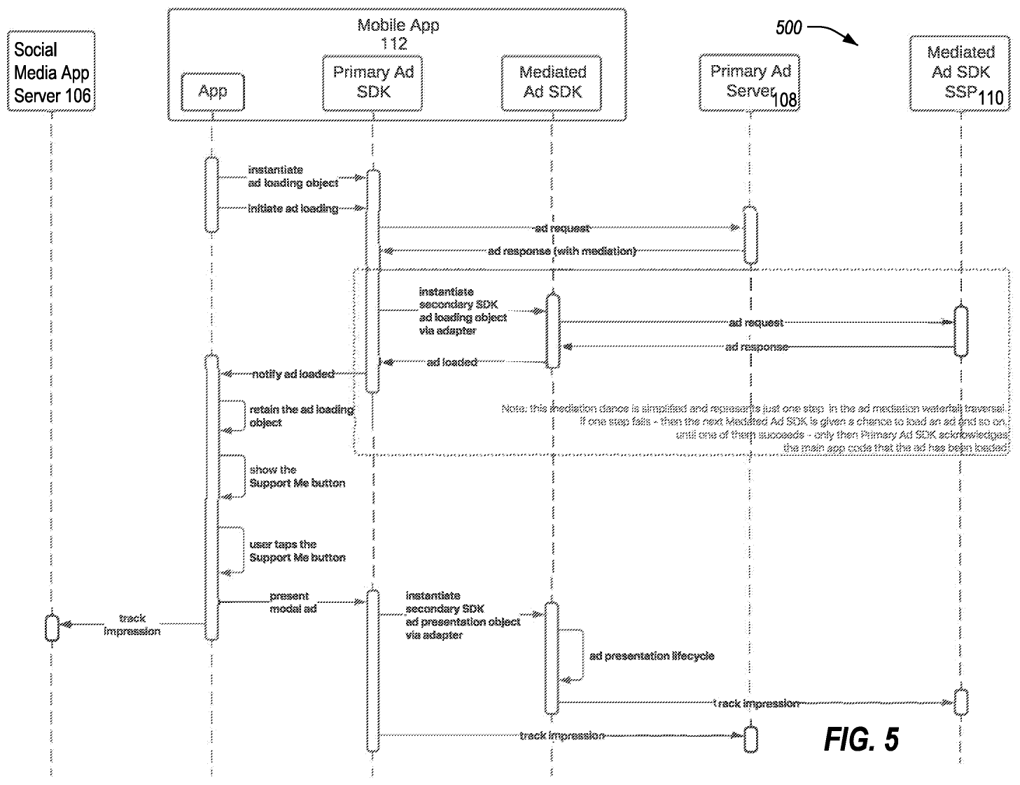

FIG. 5 illustrates an example data flow 500 for advertisements provided for viewing using the support me icon 206. The data flow may be initiated by the social media mobile application 112 responsive to the mobile application 112 identifying that an ad is to be displayed to the user. This may occur, in an example, responsive to or anticipation of the user selecting the support me icon 206 discussed above. It should be noted that the data flow is just an example, and variations in operations or order of operations are possible.

The social media mobile application 112 may instantiate an ad loading object. This may include calling into a primary ad component linked to or otherwise accessible to the social media mobile application 112. Once instantiated, the social media mobile application 112 may initiate the loading of an ad. The initiating of the loading of the ad may, in turn, cause the primary ad component to make an ad request to the primary ad server 108. This request may, for example, be performed by the mobile device 102 over the communications network 104 to the primary ad server 108.

The primary ad server 108 may respond with an indication for the social media mobile application 112 to perform ad mediation using a mediated ad component of the social media mobile application 112. In response, the social media mobile application 112 may instantiate a mediated ad loading object using the mediated ad component. This mediated ad loading object may, in turn, request an ad from the mediated ad server 110. The mediated ad server 110 may provide a response including the ad. The mediated ad loading object may provide this ad to the primary ad component, which, in turn, may notify the social media mobile application 112 of the loading of the ad. It should be noted that this mediation procedure is a simplified representation. It should be noted in other examples, there may be multiple mediated ad servers 110, each of which may be requested to provide the ad (either sequentially or in parallel), where the first mediated ad server 110 to provide an ad completes the process and allows the primary ad component to notify that an ad has been received.

The social media mobile application 112 may retain an ad loading object and may display the support me icon 206 in association with a post 204 (as shown in FIG. 2, for instance). Responsive to the user selecting the support me icon 206, the ad may be presented modally (as shown in FIG. 3, for instance). This may involve an instantiation of a secondary mediated ad object (or reuse of an existing object), to provide for the continued lifecycle of the presentation of the ad. For instance, if the ad is a video, then the lifecycle of the ad includes to display the video until completion, where the ad is only considered viewed once playback has been completed. Upon completion of playback, the mediated ad object may contact the mediated ad server 110 to indicate that the ad impression was performed. This allows the mediated ad server 110 to track the views of the ad as well as what revenue is due to the social network. Additionally, upon completion of playback, the primary ad object may contact the primary ad server 110 to indicate the ad was viewed.

Moreover, and importantly, upon completion of playback the social media mobile application 112 may inform the social media application server 106 that the ad was played back for the corresponding post 204. This allows the social network to track items such as which ad was watched, who watched the ad, and what post 204 should be allocated a share of the ad revenue.

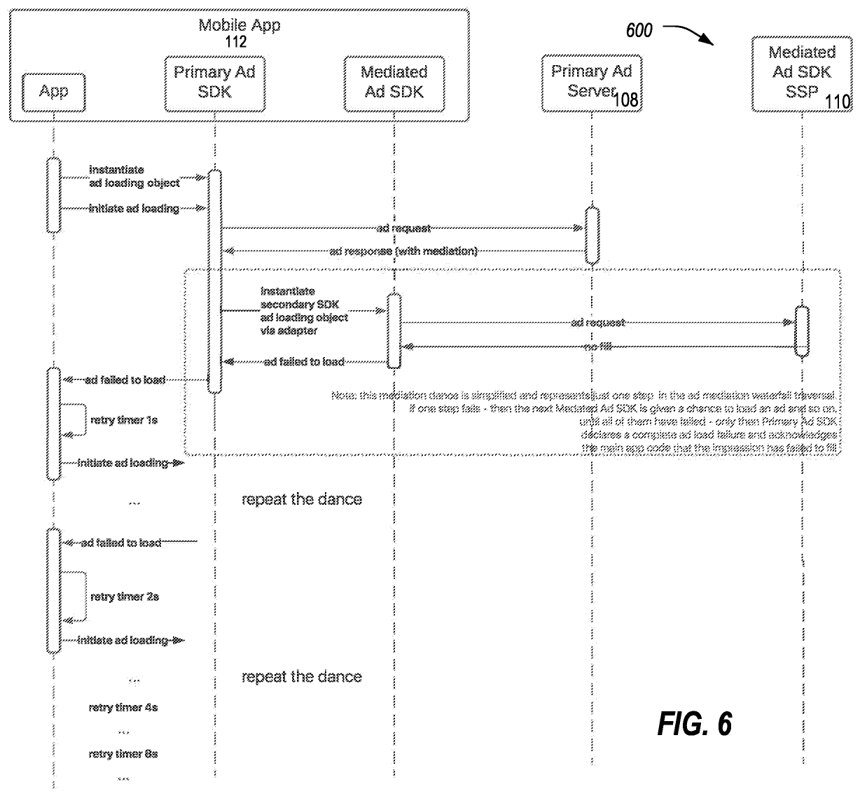

FIG. 6 illustrates an example data flow 600 for retry mechanics of the delivery of advertisements provided for viewing using the support me icon 206. As with FIG. 5, this data flow may be initiated by the social media mobile application 112 responsive to the mobile application 112 identifying that an ad is to be displayed to the user.

Also, and similar to shown in FIG. 5, the social media mobile application 112 may instantiate an ad loading object. This may include calling into a primary ad component linked to or otherwise accessible to the social media mobile application 112. Once instantiated, the social media mobile application 112 may initiate the loading of an ad. The initiating of the loading of the ad may, in turn, cause the primary ad component to make an ad request to the primary ad server 108. This request may, for example, be performed by the mobile device 102 over the communications network 104 to the primary ad server 108. The primary ad server 108 may respond with an indication for the social media mobile application 112 to perform ad mediation using a mediated ad component of the social media mobile application 112. In response, the social media mobile application 112 may instantiate a mediated ad loading object using the mediated ad component. This mediated ad loading object may, in turn, request an ad from the mediated ad server 110. However, as opposed to as shown in FIG. 5, here the mediated ad server 110 is unable to fill the request.

In response, an ad failed to load message is returned from the mediated ad loading object to the primary ad component. The primary ad component, in turn, informs the social media mobile application 112 of the failure. This may allow for a retry action to be performed by the social media mobile application 112 after expiration of a retry timer. This retry action may continue, for example, until a final timeout expires or until an ad is shown. If no ad is shown, then a stock ad may be provided instead. However, the display of the stock ad does not generate revenue, and in such a situation there may be no revenue to share with the content creating user. In other example, the social media application server 106 may still attempt to credit the content creating user with some amount of revenue, which may, for example, come from another source such as the social network's share of ad revenue from other ad impressions.

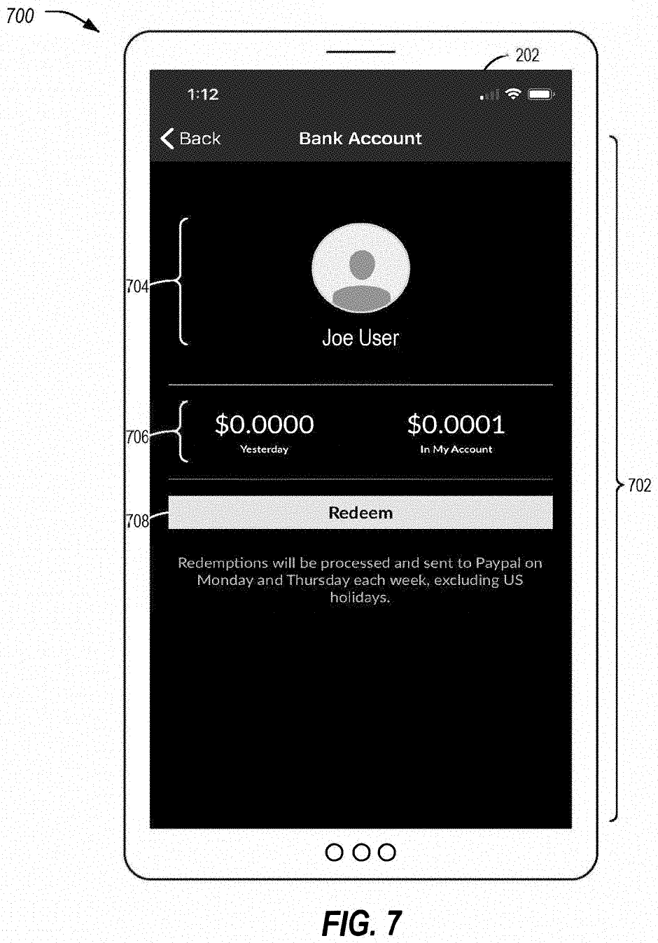

FIG. 7 illustrates an example user interface 700 displaying an account balance screen 702 for a user of the social network. The account balance screen may be shown to the user responsive to the user navigating into the user's profile settings, as one example. As shown, the account balance screen 702 may include information 704 about the user, such as name and a profile picture. The account balance screen 702 may also include information indicative of the user's total account balance. This may be used to allow the user to view the amount of ad revenue that has been shared with the user by virtue of other users of the social network clicking the support me icon 206 for posts of the user. To aid in showing the user how his or her balance is growing, the balance may show both the amount of revenue recently earned by the user (in this example for the previous day) as well as the total revenue included in the user's account.

The account balance screen 702 may also include a redeem button 708 or other control that may be used to allow the user to transfer the account balance, as shown, to a user account outside the social network. Accordingly, the content creating user may be supported via a portion of the ad revenue received from users watching ads provided in response to clicking the support me icon 206. This support may encourage the content creating user to provide additional quality content to the social network. Moreover, because the user clicking the support me icon 206 volunteered to view the ad, user experience for the social network is maintained. Yet further, because viewing the ad is consensual, the likelihood of the viewing user responding favorably to the ad is increased.

It should be noted that other revenue-sharing possibilities may be provided. For instance, support may be accomplished by users sending a tip from their account balances to the account balance of other users. In another example, the social network itself may provide tips to the users, for example to encourage them to continue to stay involved with the social network.

Within the social network, a user may be able to create his or her own storefront. To populate the user's store, the user may add items to the store from various e-commerce website (e.g., Amazon, E-Bay, Walmart, or his/her Shopify website, etc.). Then, when creating a social network post, the user can tag items from their store in a piece of content they intend to post. This will alert users that the item is for sale. A viewing user of the social media post may be able to click through the post to the user's store to purchase the item. This may allow users to be able to make purchases within the social network.

When an item is purchased, an affiliate purchase fee may be provided from the seller. The user whose content post included the tagged items may then be rewarded based on a percentage of the amount of the affiliate purchase fee. If the post is shared by another user and the purchase is made through the shared post, the user who made the original post and the user that shared the post may both be rewarded.

The purchase may be made from the purchasing user's account balance within the social network (which may be added to by viewed advertisements as discussed in detail above). In another example, the purchase may be made from a credit card associated with the purchasing user's account. In some examples, the credit card may be a branded card of the social network. Further aspects of revenue sharing for in-network purchases are explained in detail below.

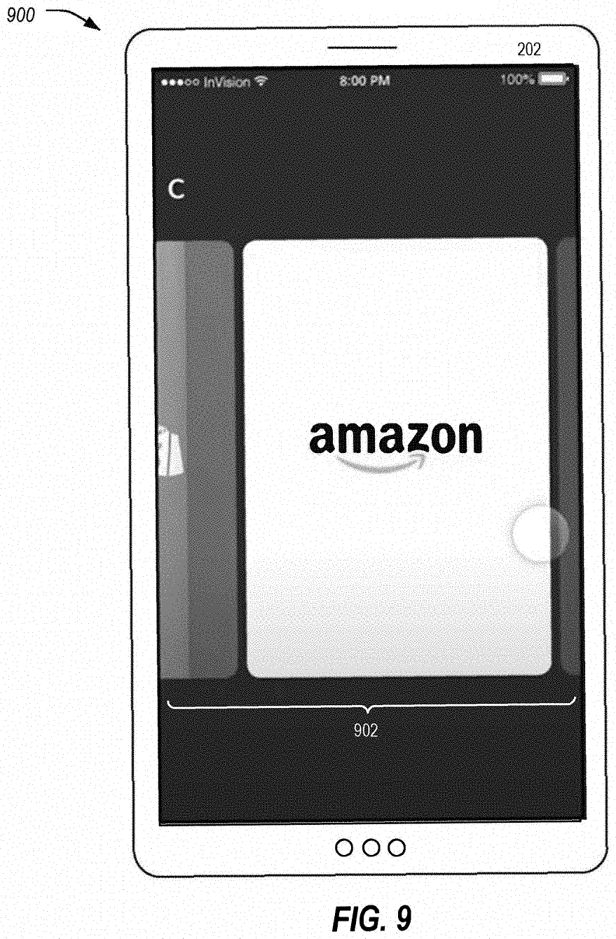

FIG. 8 illustrates an example user interface 800 displaying a store for a user of the social network. As shown, the user's shop includes a listing of items 802 that may be purchased, as well as an add items control 804 that can be selected to add additional items into the storefront. FIG. 9 illustrates an example user interface 900 displaying selection of an e-commerce website. The user interface 900 may be shown responsive to selection of the add items control 804. As shown, various stores may be swiped through by the user and selected to allow the user to add items from those e-commerce platforms into the user's store.

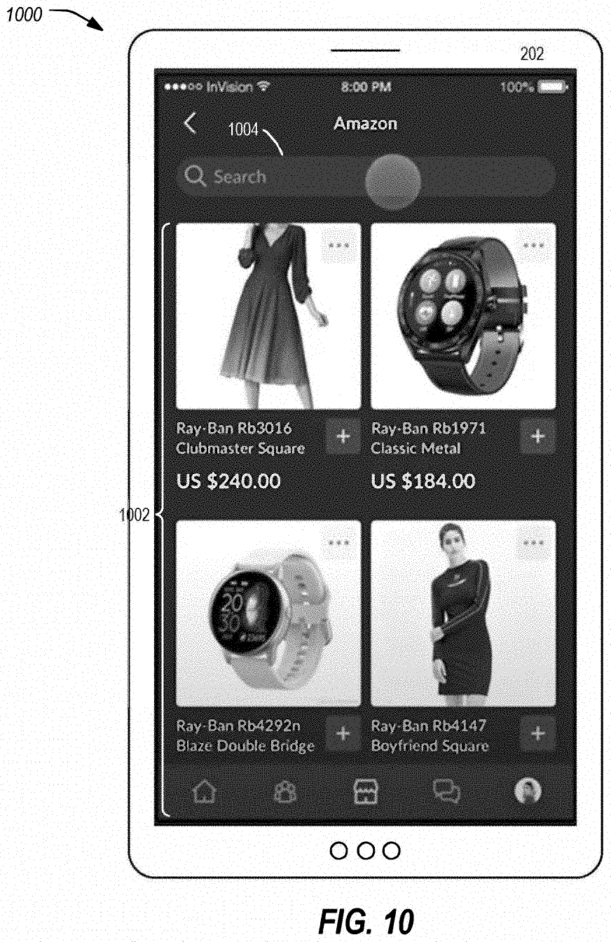

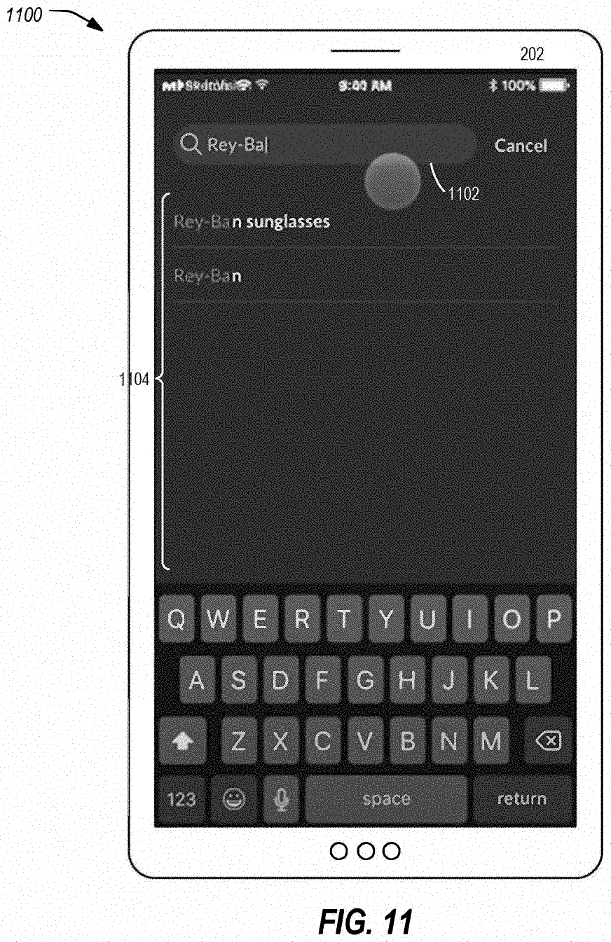

FIG. 10 illustrates an example user interface 1000 displaying items available in a selected e-commerce website. As shown, the selected store has a plurality of items 1002 for selection. Each item in the store also includes a control for adding that item to the user's own store. The user interface 100 also includes a search feature 1004 for finding items in the store. FIG. 11 illustrates an example user interface 1100 displaying a search feature for finding items available in a selected e-commerce website. The user interface 1100 may be shown responsive to selection of the search feature 1004. The search bar 1102 may be used to enter search terms, and the suggested results 1104 for the search terms.

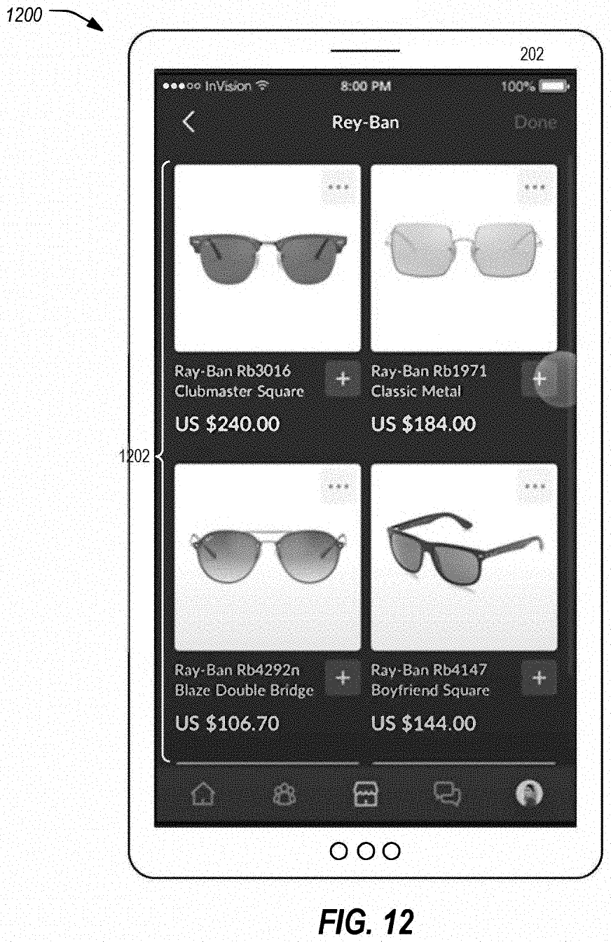

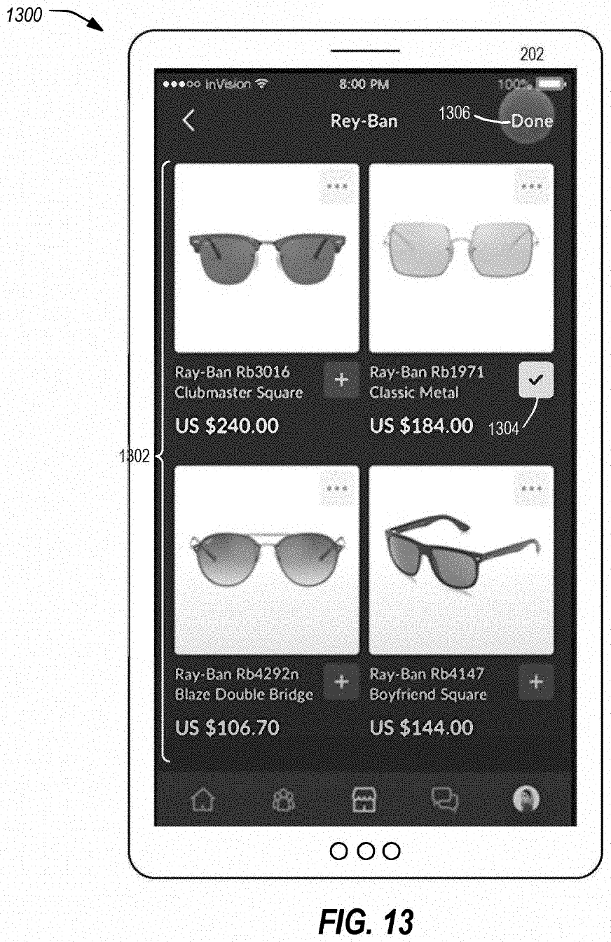

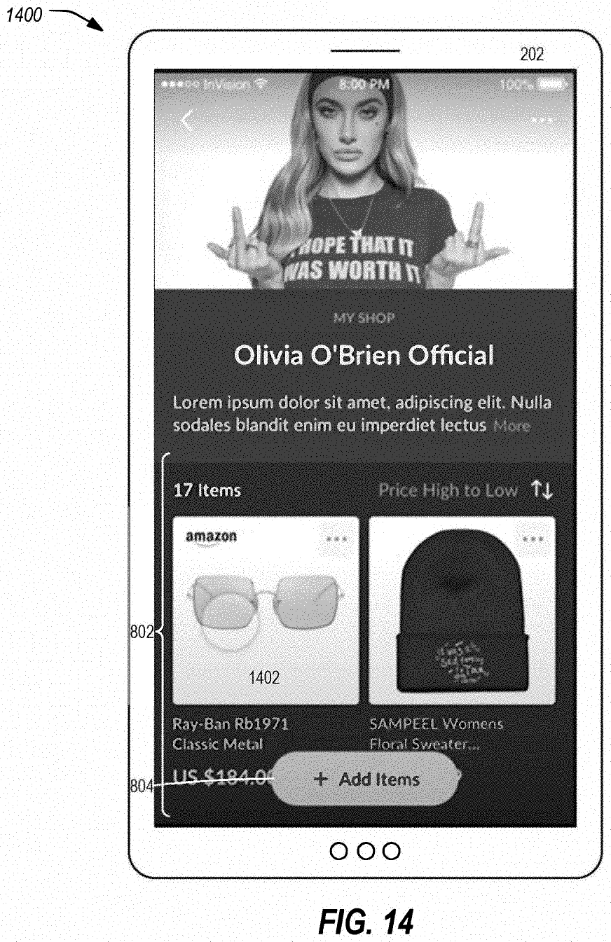

FIG. 12 illustrates an example user interface 1200 displaying found items located using the search feature. As shown, a list of matching items 1202 is shown in the user interface, each of which may be selectable to add to the store. FIG. 13 illustrates an example user interface 1300 displaying the list of matching items 1202 along with selection 1304 of an item from the e-commerce website. Additionally, the done control 1306 is now enabled as items have been selected for inclusion into the user's store. FIG. 14 illustrates an example user interface 1400 displaying the store for a user of the social network including the newly added item 1402. The store, as updated, may be shown after section of the done control 1306. Once added, the item is now available for inclusion in social media posts.

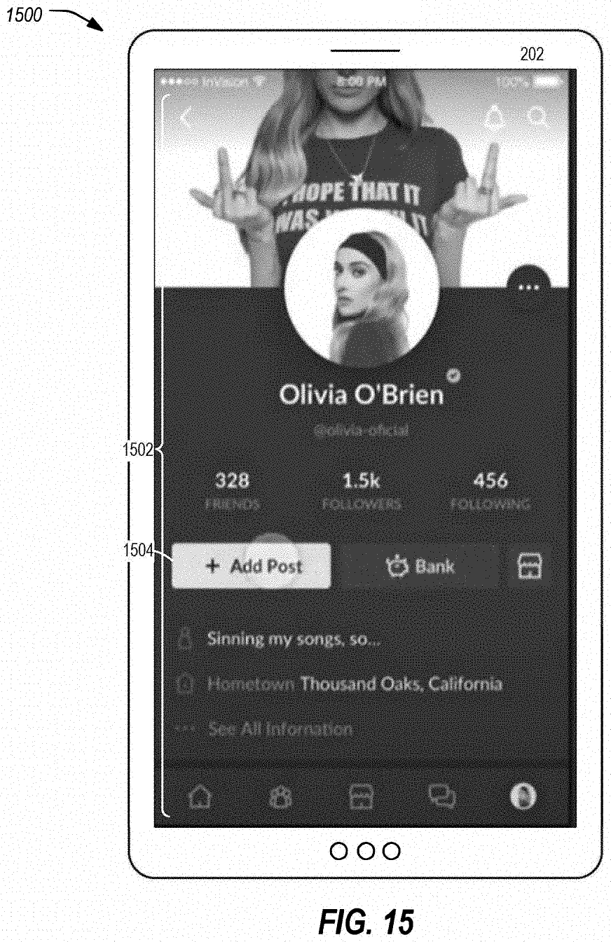

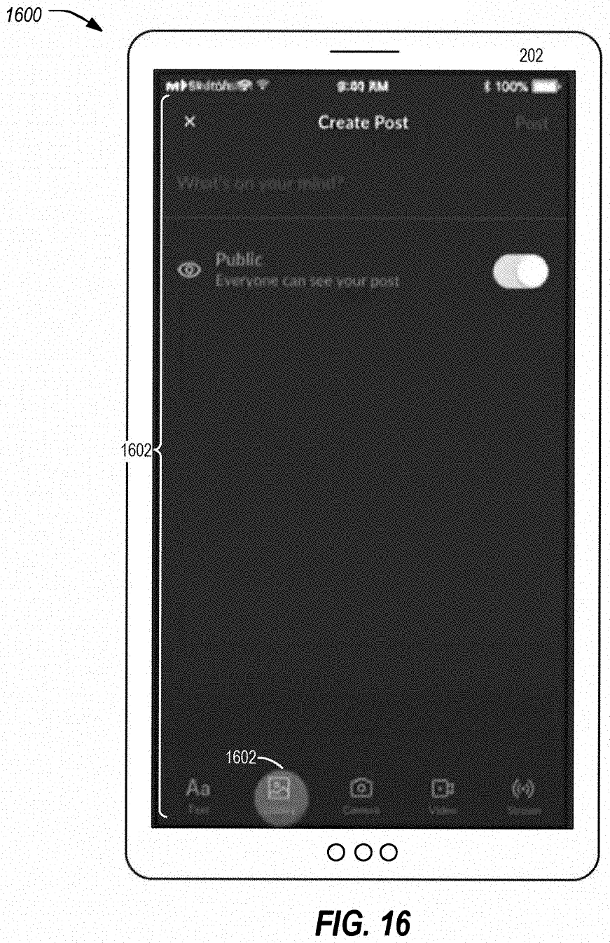

FIG. 15 illustrates an example user interface 1500 displaying a profile page 1502 for a user adding a post. The profile page 1502 includes an add post control 1504 that, when selected, allows the user to add a post to their social media account. FIG. 16 illustrates an example user interface 1600 displaying a create post screen. This screen may be shown responsive to selection of the add post control 1504. The screen may include various controls for adding content to a post. For instance, as shown, the user may use an image library control 1602 to add an image to the post.

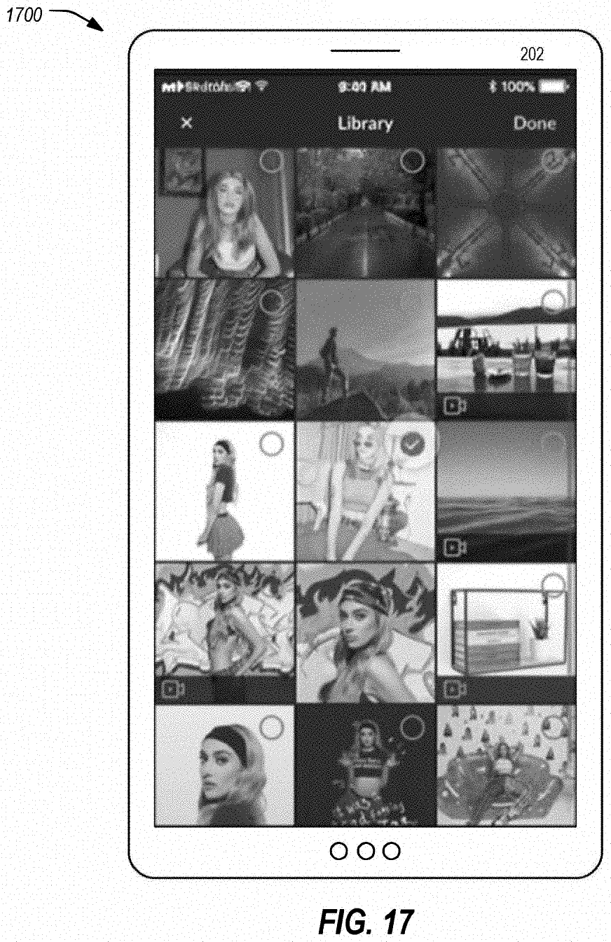

FIG. 17 illustrates an example user interface 1700 displaying an image gallery page for adding an image to a post. This screen may be shown responsive to selection of the image library control 1602. The image gallery may include images stored to the user's mobile device 102 and/or stored to the user's account with the social network. The user may select one or more images for the post from the image gallery. Once the user is done with image selection, the application may return to the create post screen.

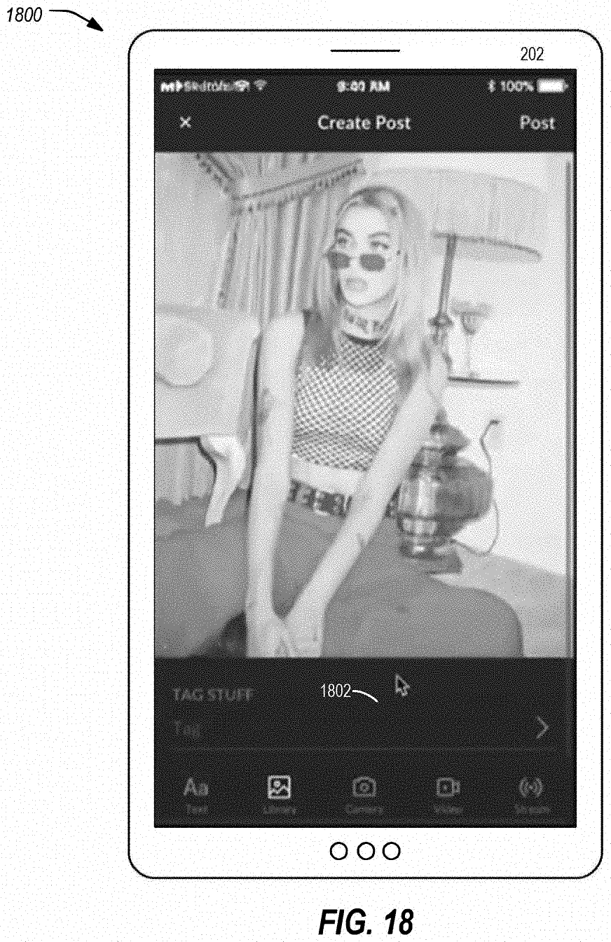

FIG. 18 illustrates an example user interface 1800 displaying the create post screen tag option. As further shown, the user may use a tag option 1802 to tag elements in the image. It should be noted that the item does not necessarily have to appear in the image.

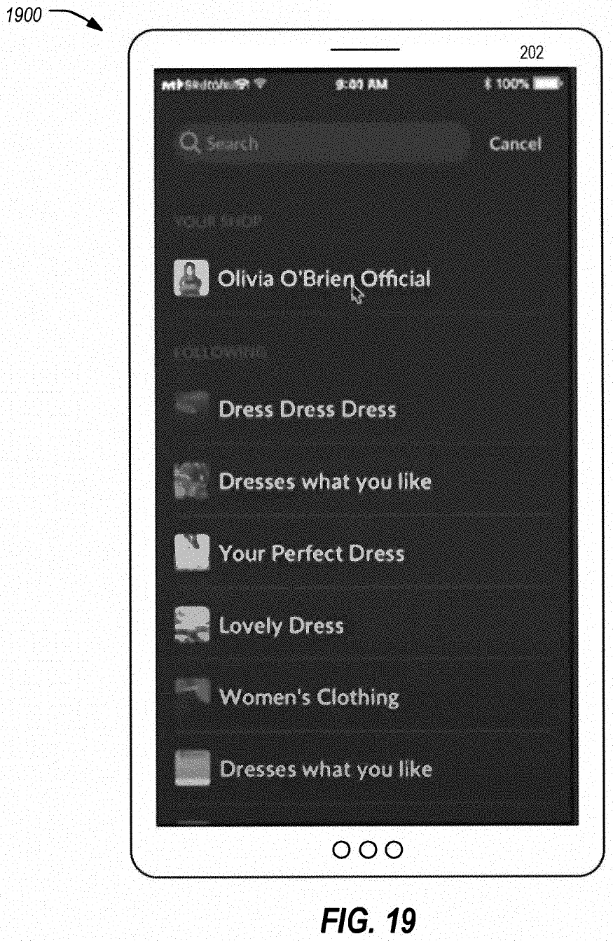

FIG. 19 illustrates an example user interface 1900 displaying a selector for the store. This may be shown, for example, responsive to selection of the tag option 1802. It should be noted that the user may select his or her own store, or another user's store.

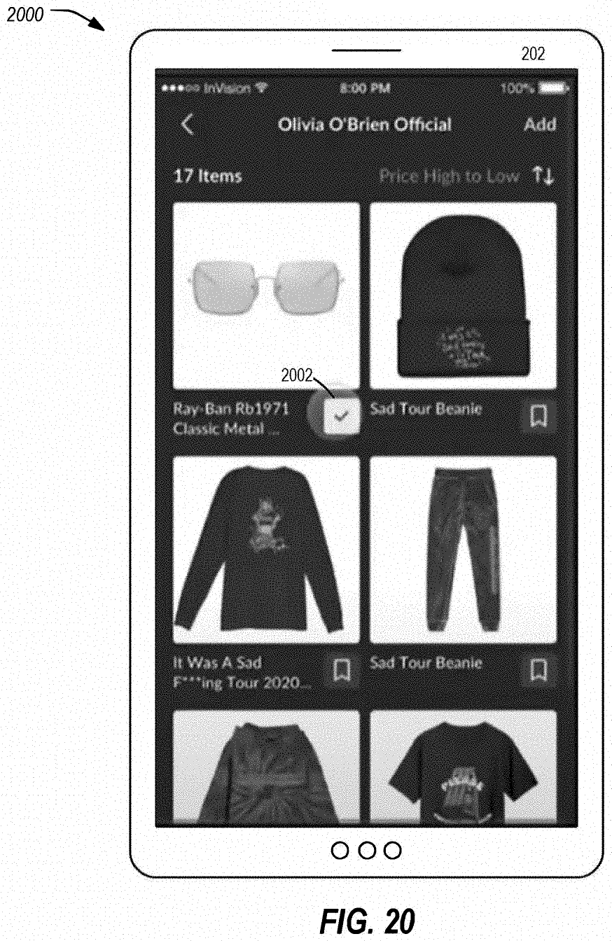

FIG. 20 illustrates an example user interface 2000 displaying a selection of items from the selected store to add to the post. This screen may be shown responsive to the selection of the store from the user interface 1900. One or more items in the store may be selected for inclusion in the social media post. As shown, each item has a tag control for selection. Notably, the control 2002 has been selected corresponding to a pair of sunglasses. Once items from the store have been selected, the user may choose the add control to complete the tagging.

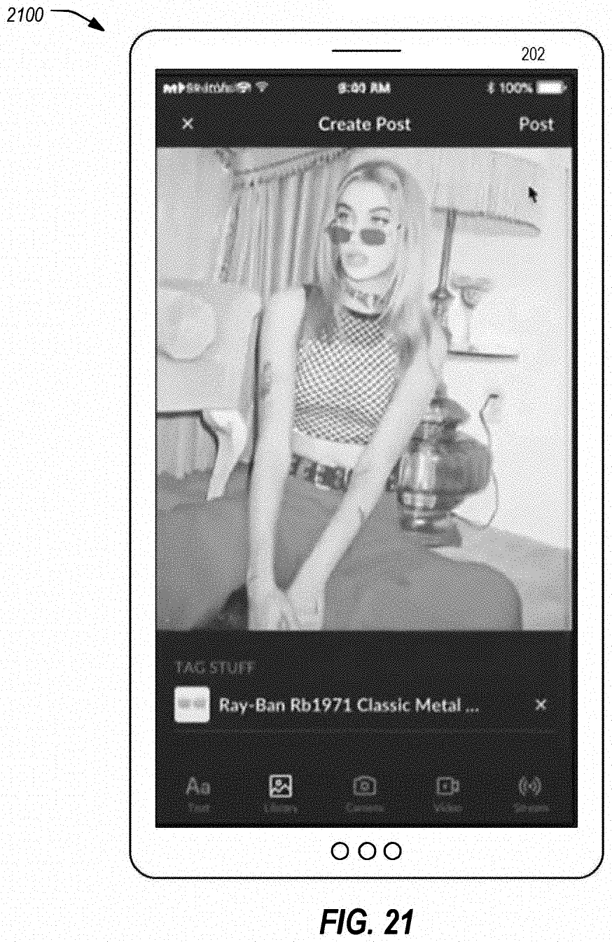

FIG. 21 illustrates an example user interface 2100 again displaying the create post screen, now including the tag for the selected item from the store. As shown, the tagged item is now listed in the tag stuff portion of the post being created. The user may select “post” to add the post to the social network.

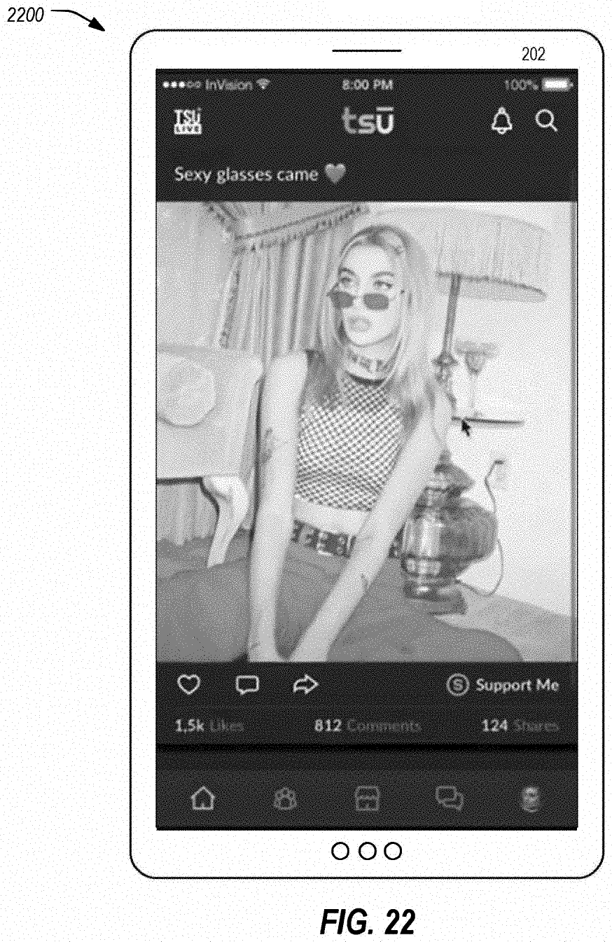

FIG. 22 illustrates an example user interface 2200 displaying the post including a tag for the selected item from the store. As can be seen, the post includes a statement regarding the item in the image, as well as the image itself.

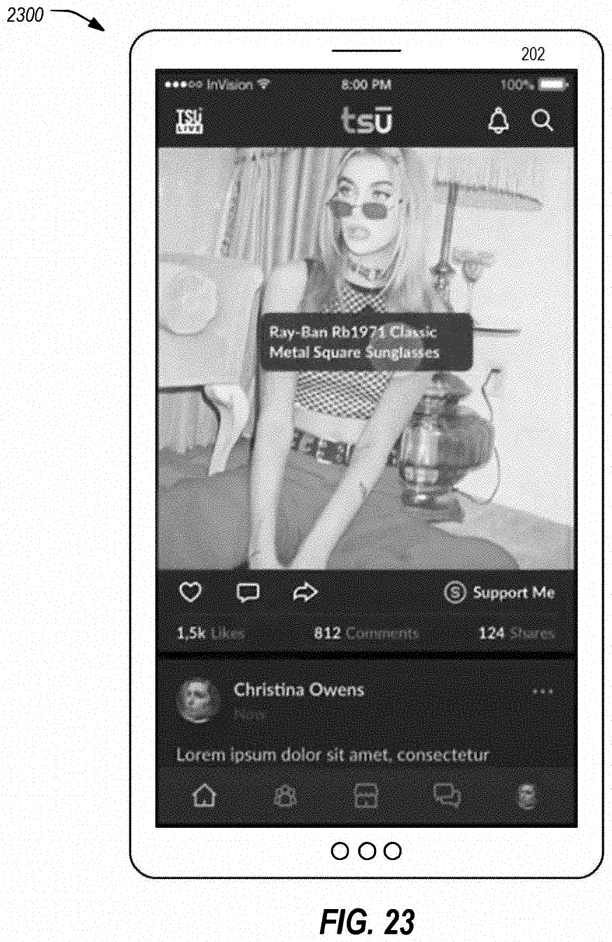

FIG. 23 illustrates an example user interface 2300 displaying further details of the post including a highlight of the tag to purchase the items from the user's store. The user may accordingly select to purchase the item from the post. This accordingly allows users of the social network to purchase items at the point of discovery.

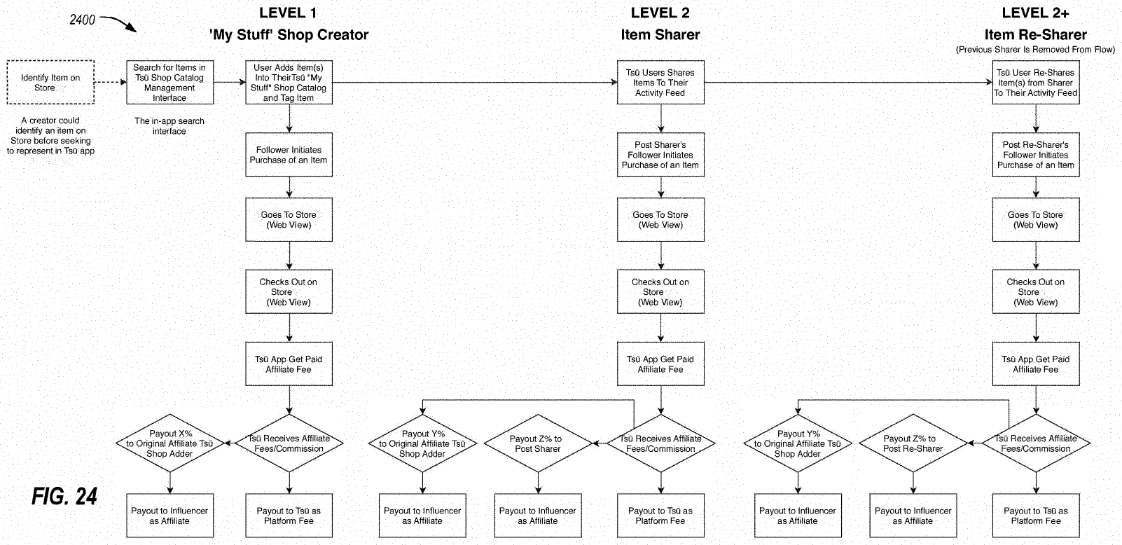

FIG. 24 illustrates an example data flow 2400 for revenue sharing for users purchasing items tagged into social media posts. The data flow may be initiated by the social media mobile application 112, responsive to the user of the mobile application 112 selecting a tagged item from a social media post of another user. It should be noted that the data flow is just an example, and variations in operations or order of operations are possible.

The data flow 2400 includes three situations, referred herein as levels. As shown, Level 0 refers to available product catalogue purchases through the affiliate network of e-commerce websites. Level 1 refers to a user's shop inventory from an available product catalogue. Level 2 refers to an affiliate or influencer referrer data flow.

As indicated in the Level 1 portion of the data flow 2400, a user may identify items as shown in FIGS. 8-14. This may include searching for items and adding the items to the user's store. A follower of the user may initiate a purchase of an item. As shown in FIGS. 15-23, a user may tag items in a social media post. The purchasing user may follow the tag in the post to the e-commerce seller and may check out of that seller to purchase the item.

Upon making the purchase, the social network is paid an affiliate fee. As indicated in the Level 1 portion of the data flow 2400, a portion of the affiliate fee is paid out the social network while a second portion of the affiliate fee is paid out to the user who added the item to his or her store. In one example, the influencer user who added the item to his/her shop receives a 50% payout award rate of the affiliate fee paid to the social network. It should be noted that this is only one example, and the exact split of the revenue may vary.

In some cases, however, the post has been shared from the posting user to another user. This is shown in the data flow as the operations of Level 2. In such a situation, a follower of the post sharer initiates the purchase, instead of a follower of the poster directly. In such situations, two influencers of the social network were involved in securing the purchase—the posting user, and the sharing user. Thus, the post sharer for his/her role in the purchase may further share in the award. In one non-limiting arrangement, the posting user and the sharing are each rewarded in equal parts based on the amount of the affiliate fee received by the social network. It should be noted that this is only one example and the exact award payout rate may vary. For instance, in another example, the original posting user may receive a greater award payout rate than the sharing user, e.g., for having to set up the store and create the post.

In still other cases, the post has been shared from the posting user to another user, and from that other user is reshared by another sharer. This is shown in the data flow as the operations of Level 2+. In such a situation, a follower of the post re-sharer initiated the purchase, instead of a follower of the poster directly or of the intermediate sharer. In such a situation, two influencers of the social network were most needed to secure the purchase—the posting user, and the final re-sharing user through which the purchasing user's decision was made. Thus, in such a situation the social network may further compensate the post re-sharer for his/her role in the purchase. In one non-limiting arrangement, the social network rewards the posting user and the re-sharing user in equal parts on an award payout rate based on a designated percentage of the affiliate fee received by the social network. It should be noted that this is only one example, and the exact award payout rate may vary. For instance, in some other examples, intermediate sharing users may also be rewarded or the percentage of the award payout rate could be lower or higher as determined by the social network.

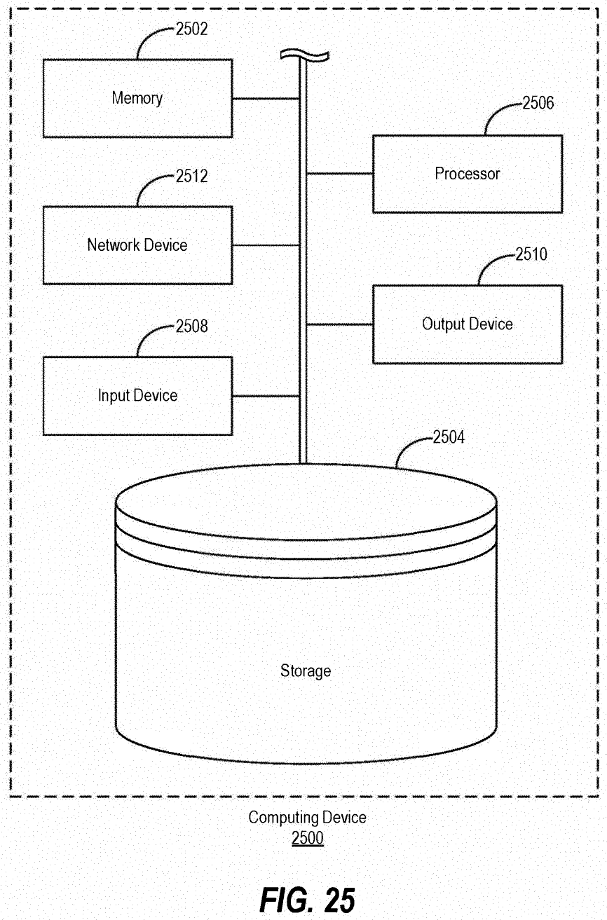

The algorithms and/or methodologies of one or more embodiments discussed herein are implemented using a computing platform, such as the computing device 2500 illustrated in FIG. 25. The computing platform 2500 may include memory 2502, a non-volatile storage 2504, a processor 2506, an input device 2508, network device 2506, an output device 2508, and an input device 2510.

The memory 2502 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 2504 may include one or more persistent data storage devices such as a hard drive, optical drive, tape drive, non-volatile solid-state device, cloud storage or any other device capable of persistently storing information.

The processor 2506 may include one or more devices selected from high-performance computing (HPC) systems including high-performance cores, microprocessors, micro-controllers, digital signal processors, microcomputers, central processing units (CPU), graphical processing units (GPU), tensor processing units (TPU), field programmable gate arrays, programmable logic devices, state machines, logic circuits, analog circuits, digital circuits, or any other devices that manipulate signals (analog or digital) based on computer-executable instructions residing in memory 2502.

The processor 2506 may be configured to read into memory 2502 and execute computer-executable instructions residing in the non-volatile storage 2504, such as those of the social media mobile application 112. Upon execution by the processor 2506, the computer-executable instructions may cause the computing device 2500 to implement one or more of the algorithms and/or methodologies disclosed herein.

The computing device 2500 may further include one or more input devices 2508, such as buttons and/or touch-sensitive displays screens, and output devices 2510 such as lights, speakers, and/or display screens. The computing device 2500 may also include one or more network devices 2512, such as modems or other wired or wireless transceivers that may be used to allow the computing device 2500 to communicate with other computing devices 2500 over the communications network 104.

Computer-readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for value sharing for a social network, comprising:
one or more servers, programmed to:
send, to a client device of a first user of the social network, a support me icon in association with a post on the social network, the post having been created by a second user of the social network, the support me icon configured to cause an advertisement to be presented to the first user responsive to selection of the support me icon by the first user;
receive, from the client device, an indication that the advertisement was presented to the first user; and
allocate, to the second user, a first portion of value corresponding to the presentation of the advertisement to the first user, thereby compensating the second user for creating the post on the social network.

2. The system of claim 1, wherein the post on the social network is available for viewing regardless of whether the support me icon is selected.

3. The system of claim 1, wherein the post on the social network is an exclusive post that is obscured by a message or is otherwise unavailable until the support me icon is selected.

4. The system of claim 1, wherein like or comment functionality of the post is disabled until presentation of the advertisement.

5. The system of claim 1, wherein the one or more servers are further programmed to allocate, to the social network, a second portion of the value corresponding to the presentation of the advertisement to the first user.

6. The system of claim 5, wherein the one or more servers are programmed to allocate the first portion of value and the second portion of value according to a periodic revenue allocation process performed for a plurality of selections of support me icons by a plurality of users.

7. The system of claim 1, wherein the one or more servers are further programmed to:
maintain account balances for each user of the social network; and
apply the first portion of value to an account balance corresponding to the second user.

8. The system of claim 7, wherein the post includes a tagged item that is for sale in a storefront of the second user, the storefront allowing for purchase of the tagged item from a seller, and the one or more servers are further programmed to allocate, once received, a portion of an affiliate purchase fee provided by the seller to the account balance of the second user based on the first user clicking through the post to the storefront and purchasing the tagged item.

9. The system of claim 8, wherein the post of the second user is shared by a third user to be viewable by the first user, and the one or more servers are further programmed to allocate a second portion of the affiliate purchase fee provided by the seller to the third user for sharing the post with the first user.

10. The system of claim 8, wherein the one or more servers are programmed to deduct a purchase cost of the tagged item from an account balance corresponding to the first user.

11. A method for value sharing for a social network, comprising:
sending, to a client device of a first user of the social network from one or more servers, a support me icon in association with a post on the social network, the post having been created by a second user of the social network, the support me icon configured to cause an advertisement to be presented to the first user responsive to selection of the support me icon by the first user;
receiving, by the one or more servers from the client device, an indication that the advertisement was presented to the to the first user; and
allocating, by the one or more servers to the second user, a first portion of value corresponding to the presentation of the advertisement to the first user, thereby compensating the second user for creating the post on the social network.

12. The method of claim 11, wherein the post on the social network is available for viewing regardless of whether the support me icon is selected.

13. The method of claim 11, wherein the post on the social network is an exclusive post that is obscured by a message or is otherwise unavailable until the support me icon is selected.

14. The method of claim 11, wherein like or comment functionality of the post is disabled until presentation of the advertisement.

15. The method of claim 11, further comprising allocating, to the social network by the one or more servers, a second portion of the value corresponding to the presentation of the advertisement to the first user.

16. The method of claim 11, further comprising allocating the first portion of value and the second portion of value according to a periodic revenue allocation process performed for a plurality of selections of support me icons by a plurality of users.

17. The method of claim 11, further comprising:
maintaining, by the one or more servers, account balances for each user of the social network; and
applying, by the one or more servers, the first portion of value to an account balance corresponding to the second user.

18. The method of claim 17, wherein the post includes a tagged item that is for sale in a storefront of the second user, the storefront allowing for purchase of the tagged item from a seller, and further comprising allocating, once received by the one or more servers, a portion of an affiliate purchase fee provided by the seller to the account balance of the second user based on the first user clicking through the post to the storefront and purchasing the tagged item.

19. The method of claim 18, wherein the post of the second user is shared by a third user to be viewable by the first user, and further comprising allocating, by the one or more servers, a second portion of the affiliate purchase fee provided by the seller to the third user for sharing the post with the first user.

20. The method of claim 18, further comprising deducting, by the one or more servers, a purchase cost of the tagged item from an account balance corresponding to the first user.

21. A non-transitory computer-readable medium comprising instructions for value sharing for a social network that, when executed by one or more servers, cause the one or more servers to perform operations including to:
send, to a client device of a first user of the social network, a support me icon in association with a post on the social network, the post having been created by a second user of the social network, the support me icon configured to cause an advertisement to be presented to the first user responsive to selection of the support me icon by the first user;
receive, from the client device, an indication that the advertisement was presented to the to the first user; and
allocate, to the second user, a first portion of value corresponding to the presentation of the advertisement to the first user, thereby compensating the second user for creating the post on the social network.

22. The medium of claim 21, wherein the post on the social network is available for viewing regardless of whether the support me icon is selected.

23. The medium of claim 21, wherein the post on the social network is an exclusive post that is obscured by a message or is otherwise unavailable until the support me icon is selected.

24. The medium of claim 21, wherein like or comment functionality of the post is disabled until presentation of the advertisement.

25. The medium of claim 21, further comprising instructions that, when executed by the one or more servers, cause the one or more servers to perform operations including to allocate, to the social network, a second portion of the value corresponding to the presentation of the advertisement to the first user.

26. The medium of claim 21, further comprising instructions that, when executed by the one or more servers, cause the one or more servers to perform operations including to allocate the first portion of value and the second portion of value according to a periodic revenue allocation process performed for a plurality of selections of support me icons by a plurality of users.

27. The medium of claim 21, further comprising instructions that, when executed by the one or more servers, cause the one or more servers to perform operations including to:
maintain account balances for each user of the social network; and
apply the first portion of value to an account balance corresponding to the second user.

28. The medium of claim 21, wherein the post includes a tagged item that is for sale in a storefront of the second user, the storefront allowing for purchase of the tagged item from a seller, further comprising instructions that, when executed by the one or more servers, cause the one or more servers to perform operations including to allocate, once received, a portion of an affiliate purchase fee provided by the seller to the account balance of the second user based on the first user clicking through the post to the storefront and purchasing the tagged item.

29. The medium of claim 28, wherein the post of the second user is shared by a third user to be viewable by the first user, further comprising instructions that, when executed by the one or more servers, cause the one or more servers to perform operations including to allocate a second portion of the affiliate purchase fee provided by the seller to the third user for sharing the post with the first user.

30. The medium of claim 28, further comprising instructions that, when executed by the one or more servers, cause the one or more servers to perform operations including to deduct, a purchase cost of the tagged item from an account balance corresponding to the first user.
